(19) United States
(12) Patent Application Publication
(10) Pub. No.: US 2013/0171392 A1
(43) Pub. Date: Jul. 4, 2013

(54) DEVICE HOUSING AND METHOD FOR MANUFACTURING SAME

(71) Applicants: REN-BO WANG, Shenzhen City (CN); XIN-WU GUAN, Shenzhen City (CN)

(72) Inventors: REN-BO WANG, Shenzhen City (CN); XIN-WU GUAN, Shenzhen City (CN)

(73) Assignees: FIH (HONG KONG) LIMITED, Kowloon (HK); SHENZHEN FUTAIHONG PRECISION INDUSTRY CO., LTD., ShenZhen City (CN)

(21) Appl. No.: 13/451,070

(22) Filed: Apr. 19, 2012

(30) Foreign Application Priority Data
Dec. 30, 2011 (CN) 201110455708.2

(51) Int. Cl. B32B 1/02; B29C 44/56; B05D 3/04; B32B 3/26

(52) U.S. Cl. 428/36.5; 428/35.7; 264/129; 264/45.1

(57) ABSTRACT

A device housing for electronic device includes a substrate comprising activated carbon particles and adhesive material for bonding and rigidifying the activated carbon particles; and a decorative coating directly formed on a surface of the substrate. A method for manufacturing the device housing is also described.

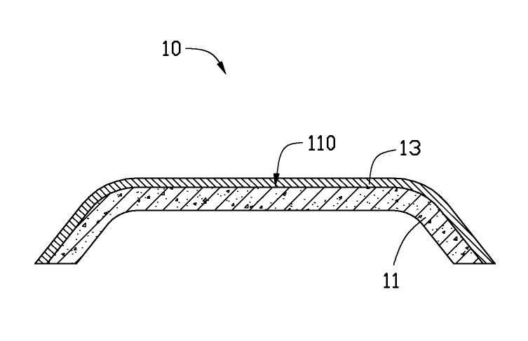

### BACKGROUND

1. Technical Field

The present disclosure generally relates to housings for electronic devices and a method for manufacturing the housings.

2. Description of Related Art

People frequently use portable electronic devices, such as mobile phones and tablet computers. However, manufacture of such electronic devices may create pollutants and infectious bacterium. The pollutants can include harmful and volatile organic compounds (such as formaldehyde and benzene) and harmful inorganic gas (such as ammonia and carbon monoxide), which are mainly from coating materials and adhesives.

Therefore, there is room for improvement within the art.

### BRIEF DESCRIPTION OF THE FIGURE

Many aspects of the disclosure can be better understood with reference to the following FIGURE. The components in the FIGURE are not necessarily drawn to scale, the emphasis instead being placed upon clearly illustrating the principles of the disclosure. Moreover, in the drawing like reference numerals designate corresponding parts throughout the views.

The FIGURE is a cross-sectional view of an exemplary embodiment of a device housing.

### DETAILED DESCRIPTION

The FIGURE shows an exemplary device housing 10 for electronic devices (such as mobile phones). In this exemplary embodiment, the device housing 10 is a cover of a mobile phone. The device housing 10 includes a substrate 11 and a decorative coating 13 directly formed on a surface 110 of the substrate 11.

The substrate 11 consists of activated carbon particles, adhesive material for bonding rigidifying the activated carbon particles, and organic impurities. The activated carbon particles are porous, having a plurality of small pores (not shown). The activated carbon particles may have an average size of about 70 μm to about 80 μm. The adhesive material may be solidified from an emulsion type polyacrylate adhesive, which is water-resistant and does not block the pores in the activated carbon particles. Within the substrate 11, the activated carbon particles may have a mass percentage of about 94%-98%; the adhesive material may have a mass percentage of about 1%-6%. In this exemplary embodiment, the substrate 11 comprises activated carbon particles at a mass percentage of about 94%, adhesive material at a mass percentage of about 5%, and organic impurities containing hydrogen, oxygen, nitrogen, and sulfur, at a total mass percentage of about 1%. The average size of the activated carbon particles is about 75 μm. The substrate 11 may have a surface porosity greater than about 35%. The substrate 11 is formed into a desired shape.

The decorative coating 13 may be made from any organic coating material or inorganic coating material, such as a paint containing dyes or pigments. The decorative coating 13 is air permeable. The decorative coating 13 may have an air permeability coefficient greater than about 80%, ensuring most of the pores of the activated carbon particles are not blocked. The decorative coating 13 mainly provides a decorative appearance for the device housing 10 and protects the substrate 11 from abrasion.

The substrate 11 of the device housing 10 comprises activated carbon particles which can absorb harmful gases, such as formaldehyde, benzene, ammonia, and carbon monoxide. Moreover, the activated carbon particles of the substrate 11 have good bactericidal effect.

A method for manufacturing the device housing 10 may include the following steps:

A paste mixture is formed by blending activated carbon particles and an adhesive material together. The activated carbon particles are porous and have a plurality of small pores. The activated carbon particles may have an average size of about 70 μm to about 80 μm. The adhesive material may be an emulsion type polyacrylate adhesive, which is water-resistant when solidified. Within the paste mixture, the adhesive material has a mass percentage of about 1%-6%; the activated carbon particles have a mass percentage of about 94%-98%.

The paste mixture may be dry-pressed to form a plate. The dry-pressing may be carried out by placing the paste mixture in a mold. The mold is heated to an internal temperature of about 80° C. to about 90° C. The paste mixture is pressed at a pressure of about 200 MPa-240 MPa by the mold for about 30 minutes to about 60 minutes, molding and solidifying the paste mixture to form a solidified plate.

A first steam activation process may treat the plate. The first steam activation process may be carried out by placing the plate in a treating chamber having water steam at a room temperature constantly fed in. When the plate is sufficient wet by the water steam and the pores of the activated carbon particles become water filled, water steam at an activation temperature of about 700° C.-950° C. may be constantly fed into the chamber. The water in the pores of the activated carbon particles rapidly vaporizes to create a large pressure in the pores and spurt out of the pores at a high pressure, thereby pushing out any substance blocked in the pores and expanding the volume of the pores. By the first steam activation process, the plate can achieve a surface porosity greater than about 35%.

A substrate 11 having a desired shape of the device housing 10 may be formed from the plate by machining. The machining may include lathe turning the plate to obtain a preliminary part having a size slightly larger than the desired size of the substrate 11, and then the preliminary part may be precisely machined to form the substrate 11. In this exemplary embodiment, the preliminary part is precise machined by numerical control machining. The substrate 11 has the surface 110.

The decorative coating 13 may be directly formed on the surface 110 of the substrate 11. The decorative coating 13 may be made from any organic coating material or inorganic coating material, such as a paint having dyes or pigments contained. The decorative coating 13 is air permeable. The decorative coating 13 may have an air permeability coefficient greater than about 80%, ensuring most of the pores of the activated carbon particles remain unblocked.

The substrate 11 with the decorative coating 13 may be treated by a second steam activation process. The second steam activation process may be carried out in the same way as the first steam action process. The second steam activation process further removes any material forming the decorative coating 13 blocked in the pores of the activated carbon particles.

The substrate 11 with the decorative coating 13 may be cleaned with a solution (e.g., alcohol or acetone) in an ultrasonic cleaner, to remove impurities such as grease or dirt. Then, the substrate 11 with the decorative coating 13 is dried.

It is believed that the exemplary embodiment and its advantages will be understood from the foregoing description, and it will be apparent that various changes may be made thereto without departing from the spirit and scope of the disclosure or sacrificing all of its advantages, the examples hereinbefore described merely being preferred or exemplary embodiment of the disclosure.

1. A device housing, comprising:
a substrate comprising activated carbon particles and adhesive material for bonding and rigidifying the activated carbon particles; and
a decorative coating directly formed on a surface of the substrate.

2. The device housing as claimed in claim 1, wherein the adhesive material is a polyacrylate adhesive.

3. The device housing as claimed in claim 2, wherein adhesive material is water-resistant.

4. The device housing as claimed in claim 1, wherein within the substrate, the activated carbon particles have a mass percentage of about 94%-98%;
the adhesive material has a mass percentage of about 1%-6%.

5. The device housing as claimed in claim 4, wherein within the substrate, the activated carbon particles have a mass percentage of about 94%; the adhesive material has a mass percentage of about 5%.

6. The device housing as claimed in claim 1, wherein the activated carbon particles have an average size of about 70 μm to about 80 μm.

7. The device housing as claimed in claim 1, wherein the substrate has a surface porosity greater than about 35%.

8. The device housing as claimed in claim 1, wherein the decorative coating is a paint layer containing dyes or pigments.

9. The device housing as claimed in claim 8, wherein the decorative coating has an air permeability coefficient greater than about 80%.

10. A method for manufacturing a device housing, comprising:
blending activated carbon particles and an adhesive material to form a paste mixture;
dry-pressing the paste mixture to form a solidified plate;
treating the plate by a first steam activation process;
forming a substrate having a desired device housing shape by machining the plate;
forming a decorative coating directly on a surface of the substrate; and
treating the substrate with the decorative coating by a second steam activation process.

11. The method as claimed in claim 10, wherein the dry-pressing step includes:
placing the paste mixture in a mold;
heating the mold to an internal temperature of about 80° C. to about 90° C. and pressing the paste mixture in the mold at a pressure of about 200 MPa-240 MPa for about 30 minutes to about 60 minutes.

12. The method as claimed in claim 10, wherein during the first steam activation process, the plate is placed in a treating chamber having water steam at a room temperature constantly fed in; and when the plate is sufficient wet, water steam at an activation temperature of about 700° C.-950° C. is constantly fed into the treating chamber.

13. The method as claimed in claim 12, wherein the second steam activation process is carried out in the same way as the first steam activation process.

14. The method as claimed in claim 10, wherein the machining step includes lathe turning the plate to obtain a preliminary part having a size slightly larger than the desired size of the substrate, and then precisely machining the preliminary part to form the substrate.

15. The method as claimed in claim 10, wherein the adhesive material is an emulsion type polyacrylate adhesive.

16. The method as claimed in claim 10, wherein within the paste mixture, the adhesive material has a mass percentage of about 1%-6%; the activated carbon particles have a mass percentage of about 94%-98%.

17. The method as claimed in claim 10, wherein the activated carbon particles have an average size of about 70 μm to about 80 μm.

18. The method as claimed in claim 10, wherein the plate achieves a surface porosity greater than about 35% by the first steam activation process.
